(19) United States
(12) Patent Application Publication
(10) Pub. No.: US 2002/0114739 A1
(43) Pub. Date: Aug. 22, 2002

(54) Microfluidic cartridge with integrated electronics

(76) Inventors: Bernard H. Weigl, Seattle, WA (US); C. Frederick Battrell, Redmond, WA (US); Stephen P. Foley SR., Waynesville, OH (US); William E. Lemay, Waynesville, OH (US); Ramachandra Mukkamala, Dayton, OH (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 10/035,755

(22) Filed: Dec. 24, 2001

Related U.S. Application Data
(60) Provisional application No. 60/258,289, filed on Dec. 26, 2000.

(51) Int. Cl. B01L 11/00

(52) U.S. Cl. 422/100; 604/19

(57) ABSTRACT

A microfluidic device which comprises a microelectronic chip that is remotely coupled to external power and data sources. The device includes a body structure, at least one microscale channel within the structure, a port for introducing fluid into the channel, a microelectronic chip internal to the structure, and a power source external to the structure coupled remotely to said structure by non-contact means. Various structures are described which embody the invention.

### CROSS REFERENCE TO RELATED APPLICATIONS

This patent claims benefit from U.S. Provisional Patent Application Serial No. 60/258,289, filed Dec. 26, 2000, which application is incorporated herein by reference.

### BACKGROUND OF THE INVENTION

1. Field of Invention

This invention relates generally to microfluidic systems, and, in particular, to a microfluidic device comprising a microelectronic device that is operated and powered remotely.

2. Description of the Related Art

Microfluidic devices have become very popular in recent years for performing analytical testing. Using tools developed by the semiconductor industry to miniaturize electronics, it has become possible to fabricate intricate fluid systems which can be inexpensively mass produced. Systems have been developed to perform a variety of analytical techniques for the acquisition and processing of information. Microfluidics are generally defined as a fluid passage which has at least one internal cross-sectional dimension that is less than 500 μm and typically between about 0.1 μm and about 500 μm.

U.S. Pat. No. 5,716,852 is an example of such a device. This patent teaches a microfluidic system for detecting the presence of analyte particles in a sample stream using a laminar flow channel having at least two input channels which provide an indicator stream and a sample stream, where the laminar flow channel has a depth sufficiently small to allow laminar flow of the streams and length sufficient to allow diffusion of particles of the analyte into the indicator stream to form a detection area, and having an outlet out of the channel to form a single mixed stream. This device, which is known as a T-sensor, allows the movement of different fluidic layers next to each other within a channel without mixing other than by diffusion.

Microfluidic systems of this type require some type of external fluidic driver, such as piezoelectric pumps, microsyringe pumps, electroosmotic pumps and the like, to operate.

Other microfluidic devices, as shown in U.S. patent application Ser. No. 09/415404, and hereby incorporated by reference in its entirety, have demonstrated that they can be entirely driven by a readily available force, such as gravity, capillary action, absorption in porous materials, chemically induced pressures or vacuums (e.g., by a reaction of water with a drying agent), or by vacuum and pressure generated by simple manual action, rather than by an external fluidic driver requiring a separate power source having moving parts. Such a device is extremely simple to operate, can be manufactured very inexpensively, and can be used to perform many diagnostic assays using a variety of microfluidic methods.

It is desirable to provide a microfluidic device that be controlled and operated remotely by an external power source, and programmed remotely, without any direct physical contact between the microfluidic device and the controlling and programming devices, or the power source. These devices would contain a microelectronic chip incorporated within said microfluidic device. Such microfluidic devices could be implanted inside a human or animal body. They could also be used for continuous measurements without having to replace batteries. Also, a single microfluidic device could be reprogrammed for different applications. In addition, such devices could contain identifying or calibration information to be used together with the microfluidic system.

### SUMMARY OF THE INVENTION

Accordingly, it is an object of the present invention to provide a microfluidic device which contains a microelectronic chip for controlling specific functions on said device, whereas the microelectronic chip can be powered and operated from a remote site.

It is a further object of the present invention to provide a low cost disposable microfluidic device that can be adapted to medical or environmental uses, among others.

It is still a further object of the present invention to provide a microfluidic system which can perform analytical functions without the necessity of an external electrical or mechanical fluid driver system in physical contact with said microfluidic system.

It is still a further object of the present invention to provide a microfluidic system also comprising an antenna capable of receiving radio energy from a radio transmitter and transforming said energy into electrical power that can be used to operate electrical components on said microfluidic system.

These and other objects are accomplished in the present invention by a cartridge device containing microfluidic channels which perform a variety of analytical techniques for the acquisition of information. The cartridge may be constructed from a single material, such as plastic, by conventional manufacturing methods, such as injection molding, to create a low cost device in which the microelectronic chip is then introduced within said cartridge. Such a device can be used multiple times, or discarded after a single use. Fluid movement in such devices can be provided actively by the microelectronic device, or through inherently available forces such as gravity, hydrostatic pressure, capillary force, absorptive force, manually generated pressure, or vacuum, or a combination of the above, to accomplish the desired analytical analyses. Other applications for this technology include toys and advertising devices.

### BRIEF DESCRIPTION OF THE DRAWINGS

FIG. 1 is a plan view of a passive microfluidic device manufactured according to the present invention, comprising a microelectronic chip that can be RF coupled to an external programming device and power source;

FIG. 2 is a plan view depicting an active microfluidic device, representing a hematology cartridge, comprising a microelectronic chip that can be RF coupled to an external programming device and power source; and

FIG. 3 is a plan view depicting an active microfluidic device, representing a hematology cartridge, comprising a microelectronic chip that can be RF coupled to an external programming device and power source, and an antenna designed to couple external radio power, and convert it into electrical power for use in the cartridge.

### DETAILED DESCRIPTION OF THE PREFERRED EMBODIMENTS

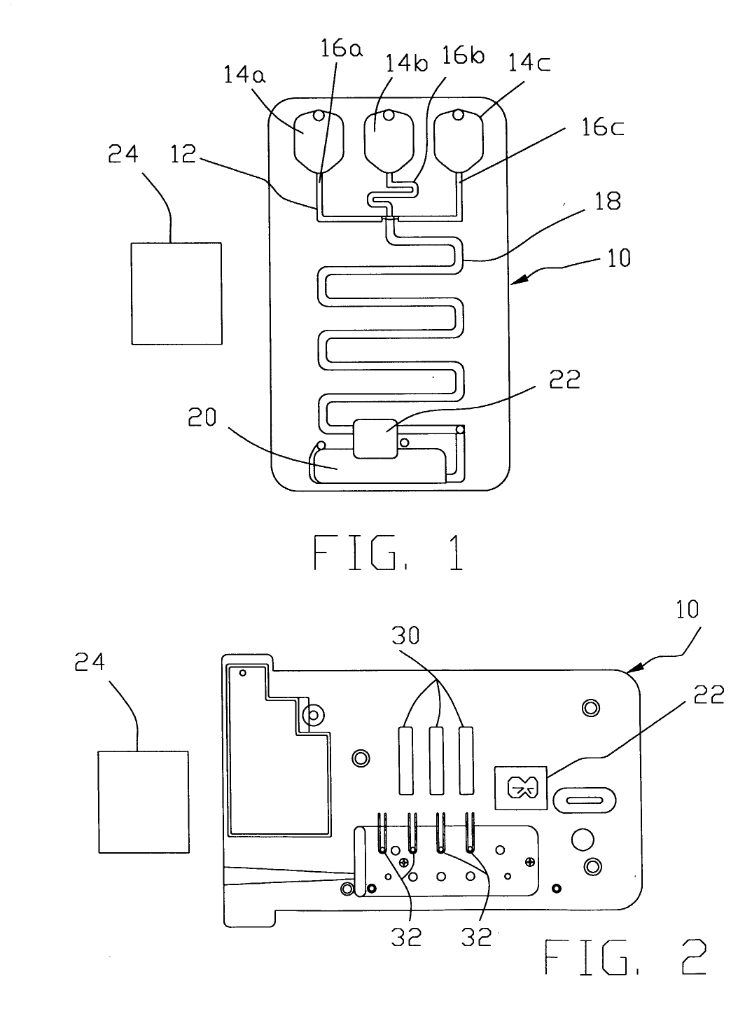

Referring now to FIG. 1, there is shown a cartridge generally indicated at 10 containing the elements of the present invention. Note that like parts are given like reference numerals in the embodiments contained in the present application. Cartridge 10 is preferably constructed from a single material, such as plastic, using a method such as injection molding, and is approximately the size and thickness of a typical credit card. Located within cartridge 10 is a flow channel system 12, preferably comprising a T-Sensor, which is described in detail in U.S. Pat. No. 5,716,852, which disclosure incorporated by reference herein. System 12 contains a series of input ports 14a, 14b, 14c having output channels 16a, 16b, 16c respectively. Channels 16a, 16b, 16c intersect at a main channel 18 which is connected to a reservoir 20. A microelectronic chip 22 is mounted within cartridge 10 as shown in FIG. 1.

In operation, T-Sensors allow the movement of different fluidic layers next to each other within channel 18 without mixing other than diffusion, as fluids generally show laminar behavior within microfluidic channels. A sample solution placed in port 14a passes through channel 16a, an indicator solution placed in port 14b passes through channel 16b and a second sample solution placed in port 14c passes through channel 14c, and the streams from channels 16a, 16b, and 16c merge in common channel 18 and flow next to each other until they exit into a reservoir 20. Smaller particles such as ions or small proteins diffuse rapidly across the fluid boundaries within channel 18, whereas larger molecules diffuse more slowly. Large particles, such as blood cells, show no significant diffusion within the time the flow streams are in contact. An interface zone is formed between the fluid layers. The signal strength of a particular optical or electrochemical property, such as fluorescence intensity of the interface zone is a function of the concentration of the analyte. This is described in detail in U.S. Pat. No. 5,948,684, which issued Sep. 7, 1999, the disclosure of which is hereby incorporated by reference in its entirety in this application. The microelectronic chip 22 embedded in cartridge 10 and may serve to provide a variety of functions such as identifying the cartridge, or to provide calibration information to a readout device that can be coupled to cartridge 10. In addition, chip 22 may also provide active functions such as measuring chemical or optical parameters within channel 18.

Manually operated microfluidic devices such as system 12 can be used to qualitatively or semi-quantitatively determine analyte concentrations. A practical use may be the determination of several parameters directly in whole blood. A color change in the diffusion zone of a T-Sensor detection channel can provide qualitative information about the presence of an analyte. This method can be made semi-quantitative by providing a comparator color chart with which to compare the color of the diffusion zone. This method would work somewhat similar to a paper test strip, but with much better control and reproducibility. In addition, long term monitoring functions can be accomplished by placing such a device in line with a sample feed. With a T-Sensor, assays can be performed directly with whole blood, whereas paper strip readings can be affected by the color and consistency of whole blood.

The accuracy of this method can be enhanced by combining the device with a readout system, which may consist of an absorbance, fluorescence, chemiluminescence, light scatter, or turbidity detector placed so that the detector can observe an optically detectable change which is caused by the presence or absence of a sample analyte or particle in the detection channel. Alternatively, electrodes can be placed within the device to observe electrochemically observable changes caused by the presence or absence of a sample analyte or particle in the detection channel.

One embodiment of this device is a disposable cartridge combined with a mass market digital camera-like detector system 24: a flash would illuminate the sensor area, and any type of optically detectable signal would be interpreted by image processing software and yield a chemical concentration or count output. Microelectronic chip 22 could then interface through RC coupling, for example, with detector system 24 and provide encoded calibration information such as specific manufacturing parameters of the cartridge lot that affect the measurement of the optically detectable signal (e. g., channel depth, optical window transmission), using any of many designs which are available to those of ordinary skill in the art. Other sources of energy for operating chip 22 include a magnetic field, microwave radiation, and infrared radiation.

FIG. 2 shows cartridge 10 which represents a class of microfluidic devices that are operated in conjunction with an external control and readout device. Cartridge 10 as shown is capable of performing a combined blood cell analysis and blood chemistry analysis. The functions of this cartridge are described in detail in U.S. patent application Ser. No. 09/080,691, entitled Liquid Analysis Cartridge, which is hereby incorporated by reference in its entirety. Cartridge 10 contains several windows 30 used for optical coupling, along with a group of valve interfaces 32 for coupling cartridge 10 to external fluid sources. Cartridge 10 also contains a microelectronic chip 22, which can perform a variety of functions such as identifying the cartridge, provide calibration information to a readout device 34 that can be coupled to cartridge 10. In addition, chip 22 may also provide active functions such as measuring chemical or optical parameters in the microfluidic system contained in cartridge 10. It may also provide fluid driving force such that the fluids can be moved around inside the microfluidic circuit without the need for pumps external to the cartridge. Such pumps may comprise electrical-field-driven electroosmotic fluid drivers, or mesopumps such as piezo-driven micropumps.

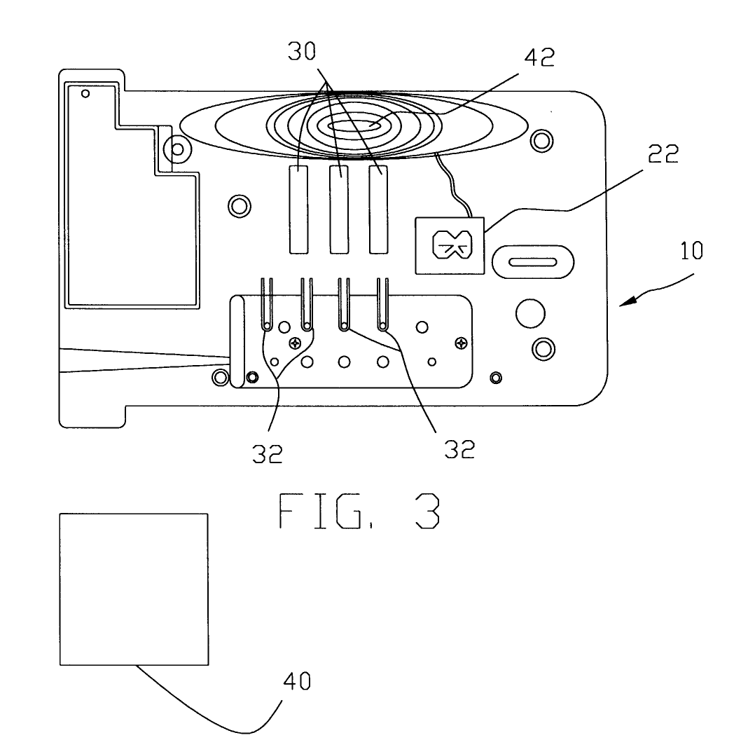

FIG. 3 shows cartridge 10 which represents a class of microfluidic devices that are operated in conjunction with an external radio power source 40. Cartridge 10 shown is capable of performing a combined blood cell analysis and blood chemistry analysis. The functions of this cartridge are described in detail in U.S. patent application Ser. No. 09/080,691, entitled Liquid Analysis Cartridge, which is hereby incorporated by reference in its entirety.Cartridge 10 contains windows 30 andvalve interfaces 32 as shown in FIG. 2. Cartridge 10 also contains a microelectronic chip 22, which can perform a variety of functions such as identifying the cartridge, provide calibration information to a readout device that can be coupled to cartridge 10. In addition, cartridge 10 also comprises a power antenna 42 that provides receives radio energy from an external transmitter 40 and converts this energy into electrical energy for operating electrical devices on cartridge 10.

The principles of the present invention can be applied to many other types of products. For example, a cartridge containing a microfluidic device as described can be used as science kits, such as a miniature chemical laboratory, for educational purposes. Another use could be as a novelty device that uses fluid flow to visualize specific patterns, such as company logos, names, signatures, and the like on a small plastic card roughly the size of a standard credit card.

While the invention has been shown and described in terms of several preferred embodiments, it will be understood that this invention is not limited to these particular embodiments and that many changes and modifications may be made without departing from the true spirit and scope of the invention as defined in the appended claims.

What is claimed is:

1. A microfluidic device, comprising:
a body structure;
at least one microscale channel disposed within said structure;
means for introducing a fluid stream into said channel;
driving means, for propelling said fluid through said channel;
and an microelectronic chip located within said body structure and capable of being coupled to an external power source without physical contact, for storing information relative to said device and for controlling operation of said device such that said microelectronic chip can be controlled remotely.

2. The microfluidic device of claim 1, wherein said microelectronic chip is coupled to an external power source by means of RF.

3. The microfluidic device of claim 1, wherein said microelectronic chip is coupled to an external power source by means of infrared radiation.

4. The microfluidic device of claim 1, wherein said microelectronic chip is coupled to an external power source by means of a magnetic field.

5. The microfluidic device of claim 1, wherein said microelectronic chip is coupled to an external power source by means of microwave radiation.

6. The microfluidic device of claim 1, wherein said microelectronic chip is capable of being programmed with data containing information for carrying out specific functions in the operation of said device.

7. The microfluidic device of claim 6, wherein said specific function is to uniquely identify said microfluidic device.

8. The microfluidic device of claim 6, wherein said specific function is to provide data for calibrating said microfluidic device.

9. The microfluidic device of claim 6, wherein said specific function is to detect the presence or concentration of a substance contained within said microfluidic device.

10. The microfluidic device of claim 6, wherein said specific function is to move fluids through said microfluidic device.

11. The microfluidic device of claim 1, wherein said device is implantable within the body of a human or an animal.

12. The microfluidic device of claim 11, further comprising a control device, located remote from said body for providing energy for controlling operation of said microfluidic device.

13. The microfluidic device of claim 12, wherein said microfluidic device is programmable by said control device which is external to said body.

14. The device of claim 1, wherein said microfluidic device further comprises detection means located within said device.

15. The device of claim 14, wherein said detection means comprises a T-Sensor.

16. The device of claim 1, wherein said microfluidic device further includes separation means located within said device.

17. The device of claim 11, wherein said microfluidic device further includes means for delivering a chemical substance into said body.

18. The device of claim 11, wherein said microfluidic device further includes means for controlling a function of said human or animal.

19. A microfluidic device, comprising:
a body structure;
at least one microscale channel disposed within said structure;
means for introducing a fluid stream into said channel;
means for receiving radio energy;
a microelectronic chip, located within said body structure and coupled to said means for receiving radio energy, for controlling introduction means; and
means for transforming said energy into electrical power for operating said chips contained in said microfluidic device.
